(19) United States
(12) Patent Application Publication
(10) Pub. No.: US 2005/0219252 A1
(43) Pub. Date: Oct. 6, 2005

(54) Two-dimensional buffer, texture and frame buffer decompression

(76) Inventors: Mark J. Buxton, Chandler, AZ (US); Brent Baxter, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/813,953

(22) Filed: Mar. 30, 2004

(51) Int. Cl. G06F 15/167; G09G 5/02

(52) U.S. Cl. 345/542

(57) ABSTRACT

A buffer logic within a memory module having the capability to carry out a test of another memory module to which it is coupled via a point-to-point bus through autonomously storing and transmitting a test pattern across that point-to-point bus to the other memory module, while further employing another buffer logic that is interposed between the two memory modules to pass on the test pattern, but intercept a signal received from the other memory module during the test and pass on an indication of the receipt of that signal to an analysis device to monitor the test.

### BACKGROUND

As graphics controllers within graphics systems have become ever faster and capable of manipulating graphics data in an ever greater variety of ways, graphics memories coupled directly to a graphics controller of ever greater size and speed have been sought. It has become commonplace for graphics controllers to incorporate support for receiving, reformatting and playing back motion video data, and it has also become commonplace for graphics controllers to implement more and more drawing and rendering functions with hardware circuitry within the graphics controller to provide increases in performance over implementing such functions in software carried out by general purpose processors that also control such graphics controllers.

This movement of functions from being implemented in software executed by a general purpose processor to being implemented by hardware circuitry within a graphics controller has also resulted in more and more of the graphics data that was previously maintained in a system memory under the control of the software executed by the general purpose processor being moved into the graphics memory, thereby requiring the graphics memory to store ever larger quantities of graphics data. Also, both the speed of graphics controllers and the assumption of ever more functions by graphics controllers require that the graphics memory supply many more portions of this ever greater quantity of graphics data to the graphics controller within a given period of time to support these functions, as well as store many more portions of graphics data received from the graphics controller as each function is carried out, at ever greater rates.

Graphics memories are typically implemented using some form of dynamic random access memory (DRAM) devices provide the benefits of higher storage densities and less power consumption in comparison to other memory technologies, including and most notably, static random access memory (SRAM) devices. However, these benefits come at the cost of incurring various delays in accessing the memory cells making up each DRAM device, resulting in the slowing down of the effective rate at which data stored within DRAM devices may be accessed. Also, just as there has been a growing disparity between the advances in performance levels achievable by general purpose processor logic versus DRAM technology, there is also a growing disparity between advances in performance levels achievable by graphics controller logic versus DRAM technology. Various schemes have been devised in the prior art to mitigate the effect of each of these delays in accessing DRAM devices such that it is sometimes possible to entirely counteract certain delays, but these various schemes achieve such mitigation only under certain circumstances that may not occur frequently enough where graphics data is concerned to be effective, and so the effect of these delays continues to be felt to a significant degree.

### DETAILED DESCRIPTION OF THE DRAWINGS

The objects, features, and advantages of the present invention will be apparent to one skilled in the art in view of the following detailed description in which:

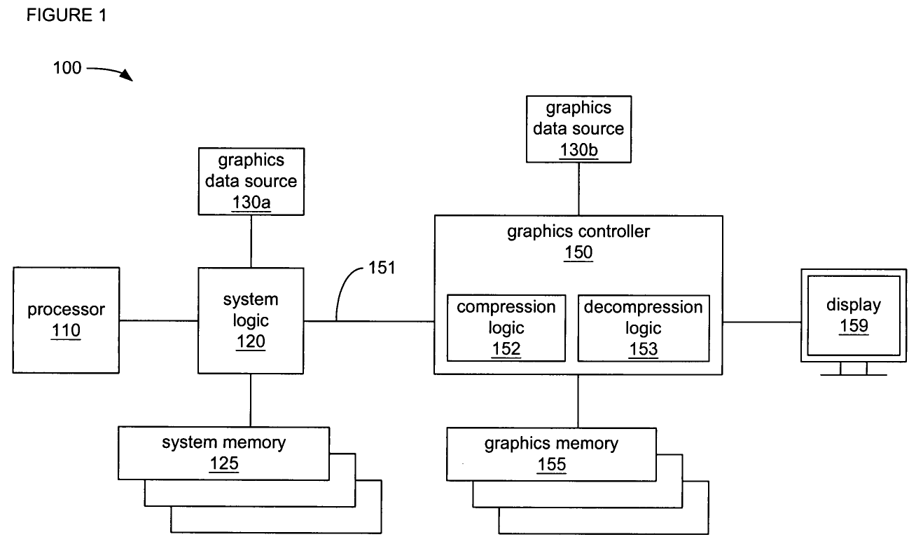

FIG. 1 is a block diagram of an embodiment employing a computer system.

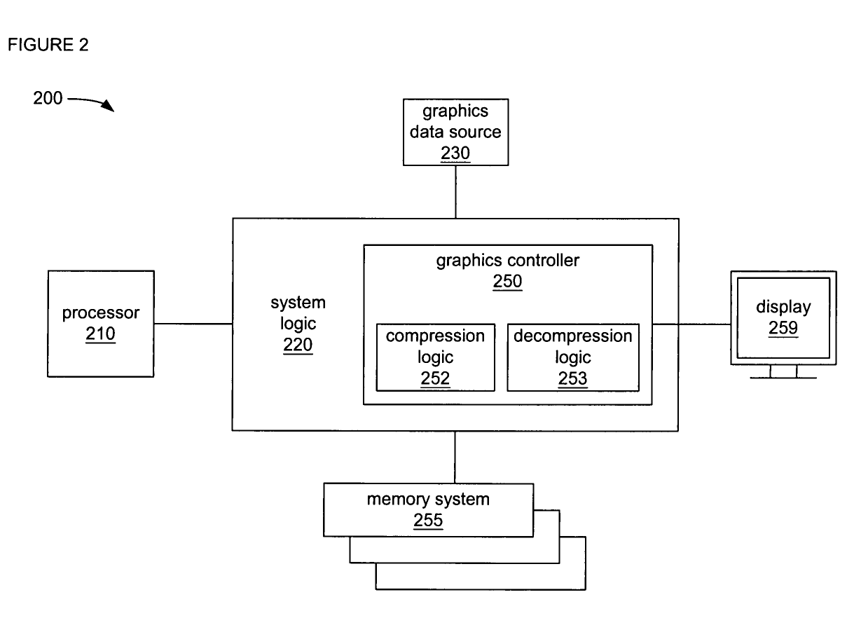

FIG. 2 is a block diagram of another embodiment employing a computer system.

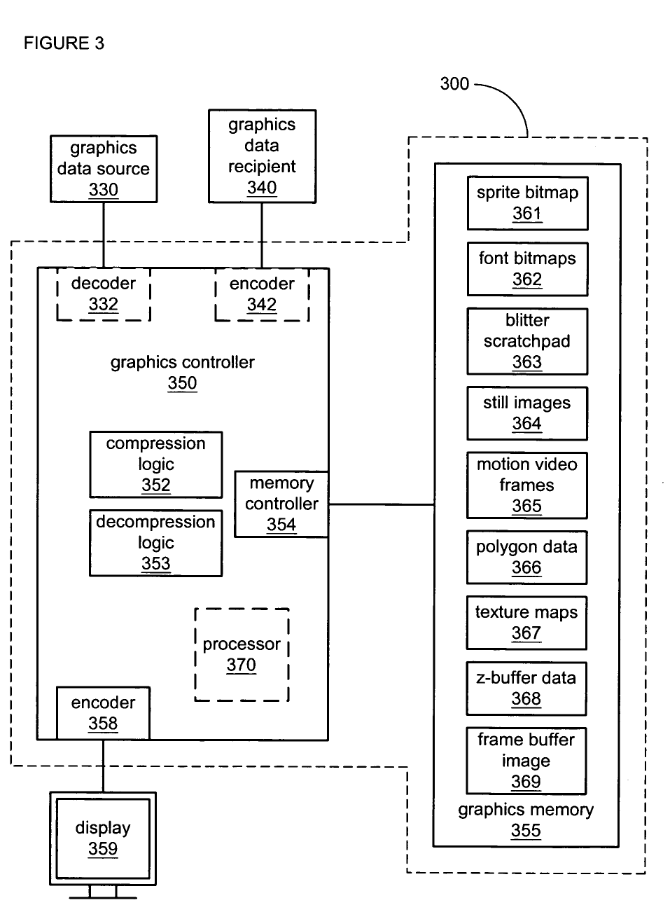

FIG. 3 is a block diagram of an embodiment employing a graphics system.

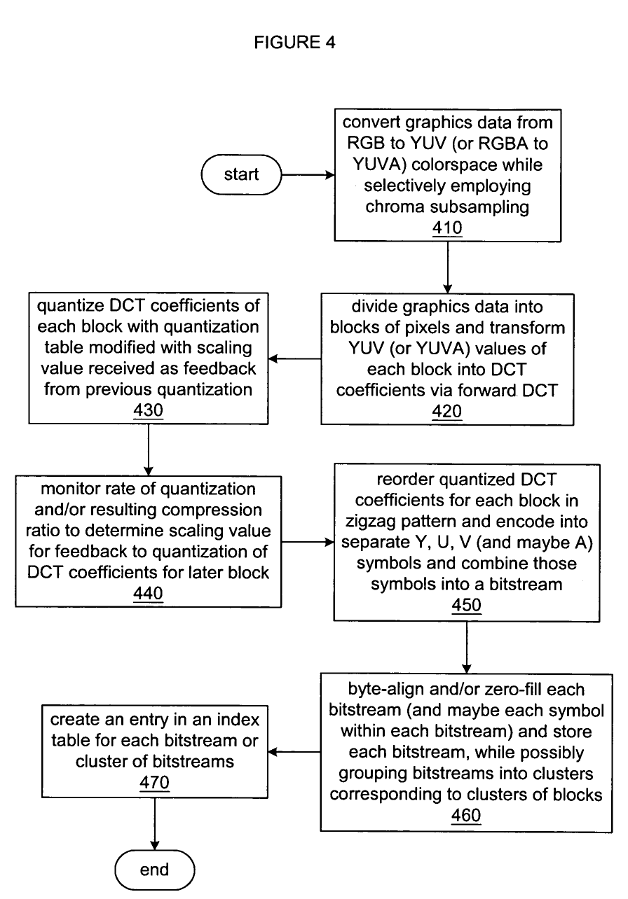

FIG. 4 is a flowchart an embodiment of graphics data compression.

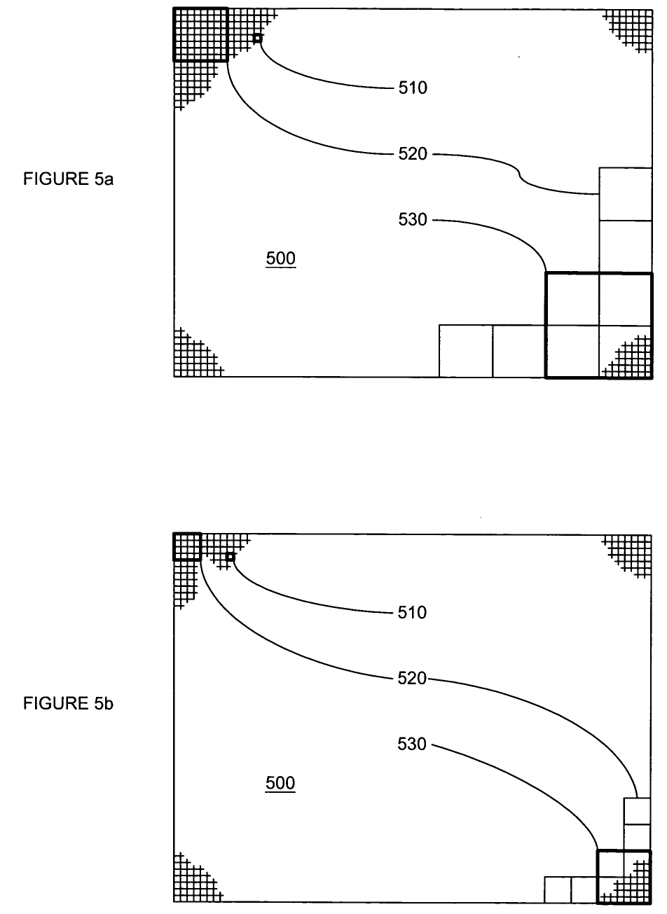

FIGS. 5a and 5b are images undergoing an embodiment of graphics data compression.

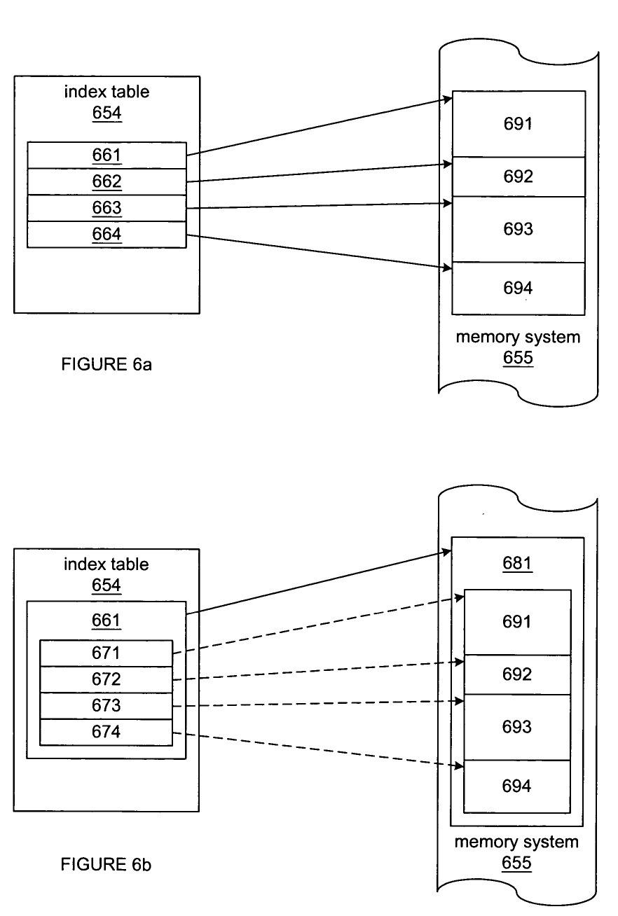

FIGS. 6a and 6b are block diagrams of embodiments employing a memory system.

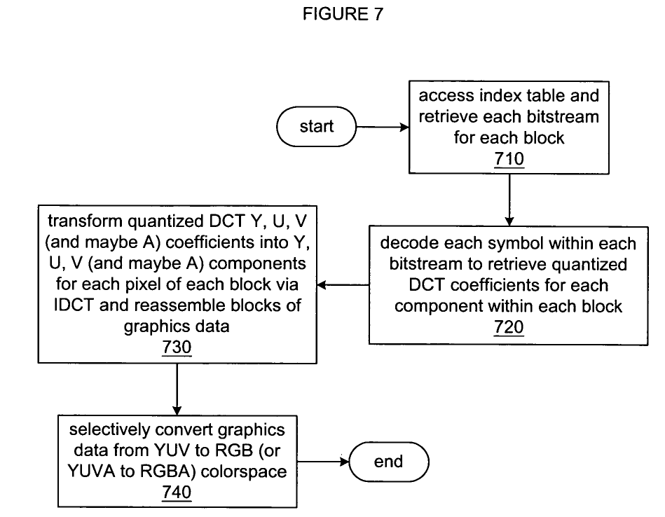

FIG. 7 is a flowchart an embodiment of graphics data decompression.

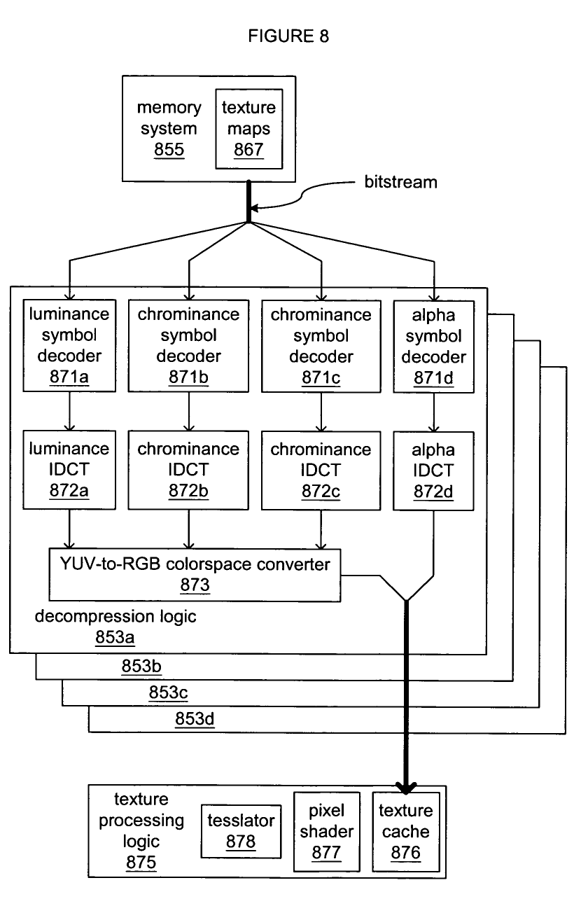

FIG. 8 is a block diagram of an embodiment employing decompression logic.

### DETAILED DESCRIPTION

In the following description, for purposes of explanation, numerous details are set forth in order to provide a thorough understanding of the present invention. However, it will be apparent to one skilled in the art that these specific details are not required in order to practice the present invention.

Embodiments of the present invention concern incorporating support within a graphics controller for compressing and decompressing graphics data stored in a graphics memory for carrying out graphics operations and/or for display. Although the following discussion centers on graphics controllers within computer systems, it will be understood that embodiments of the claimed invention may be practiced in support of a number of different types of electronic devices carrying out graphics functions and having a graphics memory.

FIG. 1 is a simplified block diagram of an embodiment employing a computer system. Computer system 100 is made up, at least in part, of processor 110, system logic 120 and system memory 125. System logic 120 is coupled to processor 110 and performs various functions in support of processor 110 including providing processor 110 with access to system memory 125 to which system logic 120 is also coupled. Processor 110, system logic 120 and system memory 125 make up a form of core for computer system 100 that is capable of supporting the execution of machine readable instructions by processor 110 and the storage of data and instructions within system memory 125.

In various embodiments, processor 110 could be any of a variety of types of processor including a processor capable of executing at least a portion of the widely known and used “x86” instruction set, and in other various embodiments, there could be more than one processor. In various embodiments, system memory 125 could be made up of any of a variety of types of random access memory (RAM) including fast page mode (FPM), extended data out (EDO), single data rate (SDR) or double data rate (DDR) forms of synchronous dynamic RAM (SDRAM), RAM of various technologies employing a RAMBUS™ interface, etc., and a memory controller within system logic 120 provides an appropriate interface for the type of memory.

Computer system 100 is also made up, at least in part, of graphics controller 150, graphics memory 155 and display 159. Graphics controller 150 is coupled to system logic 120 via bus 151, although in other embodiments, graphics controller 150 may be coupled to one or more other portions of computer system 100. Graphics controller 150 is further coupled to graphics memory 155 into which graphics controller 150 stores and from which graphics controller 150 retrieves graphics data. Graphics controller 150 and graphics memory 155 make up a graphics system to transmit an image to be displayed by display 159 to which graphics controller 150 is also coupled.

In various embodiments, graphics controller 150 could be made up of one or more than one integrated circuits. In various embodiments, like system memory 125, graphics memory 155 could be made up of any of a variety of types of random access memory, and a memory controller within graphics controller 150 provides an appropriate interface for the type of memory.

In various possible embodiments, graphics controller 150 may access one or both of system memory 125 and graphics memory 155 to store and/or retrieve graphics data. In various possible embodiments, texture maps, font bitmaps, motion video frames, etc., may be stored within system memory 125, and in various possible embodiments, font bitmaps, motion video frames, sprite bitmaps, frame buffering, lists of vertices, polygon parameters, nurbs, etc., may be stored within graphics memory 155. In some embodiments, computer system 100 may be further made up of graphics data source 130a (coupled to system logic 120 or to another component of computer system 100) through which graphics data, such as motion video data, may be received from outside computer system 100 and may be stored under the control of processor 110 within either system memory 125 or graphics memory 155 for subsequent access by graphics controller 150. In other embodiments, graphics controller 150 may directly receive such graphics data from outside computer system 100 via graphics data source 130b (coupled directly to graphics controller 150 or other component of the graphics system). Various ones of these types of graphics data may be stored in one or both of system memory 125 and graphics memory 155 by processor 110 or another component of computer system 100 to be used by graphics controller 150. Also, In addition to graphics data, processor 110 and/or other components of computer system 100 may also store commands or other operating parameters within one or both of system memory 125 and graphics memory 155 in some embodiments to control the operation of graphics controller 150. In other embodiments processor 110 may access one or more registers within graphics controller 150 to control the operation of graphics controller 150.

Graphics controller 150 is made up, at least in part, of compression logic 152 to compress graphics data to be stored, and decompression logic 153 to decompress graphics data retrieved from storage. Compression logic 152 employs a lossy compression algorithm to compress graphics data that is amenable to being compressed such that the introduction of a relatively small degree of alteration will not materially affect the utility of that graphics data, but which allows a significant ratio of compression, such as 4:1, to be consistently achieved. Such graphics data that is so amenable may be texture maps, frames of motion video data, bitmaps of fonts, etc. By contrast, other graphics data may not be so amenable to lossy compression techniques, since even small alterations may have highly undesirable effects, such as lists of vertices, polygon parameters, etc., especially where such data includes numerical data for use in calculations, such as coordinates. Decompression logic 153 employs an algorithm chosen to efficiently reverse the compression algorithm employed by compression logic 152, possibly employing parallel sets of logic that each decompress different portions of graphics data in parallel to increase the rate at which graphics data may be decompressed.

FIG. 2 is a simplified block diagram of another embodiment employing a computer system. Computer system 200 is similar to computer system 100 of FIG. 1 in many respects with a difference being that memory system 255 of computer system 200 serves the functions of both system memory 125 and graphics memory 155 of computer system 100. Like computer system 100, processor 210, system logic 220 and memory system 255 of computer system 200 are coupled together and make up a form of core for computer system 200 that is capable of supporting the execution of machine readable instructions by processor 210 and the storage of data and instructions within memory system 255. Also, somewhat like computer system 100, graphics controller 250 and at least a portion of memory system 255 of computer system 200 make up a graphics system to transmit an image to be displayed by display 259. However, somewhat unlike computer system 100, graphics controller 250 is incorporated within system logic 220, although embodiments with graphics controller 250 being coupled to other components within computer system 200 via a bus are also possible.

In various embodiments, processor 210 could be any of a variety of types of processor including a processor capable of executing at least a portion of the widely known and used “x86” instruction set, and in other various embodiments, there could be more than one processor. In various embodiments, memory system 255 could be made up of any of a variety of types of random access memory, and a memory controller within system logic 220 provides an appropriate interface for the type of memory. In various embodiments, graphics controller 250 could be integrated within system logic 220 (as shown), or may be made up of one or more separate integrated circuits.

Graphics controller 250 accesses memory system 255 to store and/or retrieve graphics data. In various possible embodiments, texture maps, font bitmaps, motion video frames, sprite bitmaps, frame buffering, lists of vertices, polygon parameters, nurbs, etc., may be stored within memory system 255. Like computer system 100, computer system 200 in some embodiments may be further made up of graphics data source 230 (coupled to system logic 220 or to another component of computer system 200) through which graphics data, such as motion video data, may be received from outside computer system 200 and may be stored, under the control of one or both of processor 210 and graphics controller 250 within memory system 255. In addition to graphics data, processor 210 and/or other components of computer system 200 may also store commands or other operating parameters within memory system 255 in some embodiments to control the operation of graphics controller 250. In other embodiments processor 210 may access one or more registers within graphics controller 250 to control the operation of graphics controller 250.

Like graphics controller 150 of computer system 100, graphics controller 250 is made up, at least in part, of compression logic 252 to compress graphics data to be stored, and decompression logic 253 to decompress graphics data retrieved from storage. Compression logic 252 employs a lossy compression algorithm to compress graphics data that is amenable to being compressed such that the introduction of a relatively small degree of alteration will not materially affect the utility of that graphics data, but which allows a significant ratio of compression, such as 4:1, to be consistently achieved. Decompression logic 253 employs an algorithm chosen to efficiently reverse the compression algorithm employed by compression logic 252, possibly employing parallel sets of logic that each decompress different portions of graphics data in parallel to increase the rate at which graphics data may be decompressed.

FIG. 3 is a simplified block diagram of an embodiment employing a graphics system. Graphics system 300 is made up, at least in part, of graphics controller 350 coupled to graphics memory 355. In turn, graphics controller 350 is made up, at least in part, of compression logic 352 to compress at least some forms of graphics data to be stored within graphics memory 355, decompression logic 353 to decompress at least some forms of graphics data retrieved from graphics memory 355, and in some embodiments, memory controller 354 to maintain an index table of address locations within graphics memory 355 at which pieces of compressed graphics data are stored. Stored within graphics memory 355 may be graphics data such as overlay bitmap 361, font bitmaps 362, blitter scratchpad 363, still image 364, motion video frames 365, polygon data 366, texture map 367, z-buffer data 368, frame buffer image 369 and/or other forms of graphics data.

Graphics controller 350 may be made up of one or more integrated circuits, and may be variously coupled to display 359 to enable the displaying of frame buffer image 369, graphics data source 330 to provide graphics data to graphics controller 350 for display, and/or graphics data recipient 340 to receive graphics data from graphics controller 350, perhaps for transmission or storage within non-volatile media. To carry out various graphics operations, such as drawing lines, copying portions of an image from one location within graphics memory 355 to another, etc., graphics controller 350 may incorporate various pieces of logic specifically designed to carry out specific subsets of such functions (not shown), or graphics controller 350 may incorporate processor 370 having the flexibility to be programmed to carryout different ones of such functions.

Graphics data making up different ones of overlay bitmap 361, font bitmaps 362, blitter scratchpad 363, still image 364, motion video frames 365, polygon data 366, texture map 367, z-buffer data 368, frame buffer image 369, etc., may or may not be compressed by compression logic 352 before being stored within graphics memory 355 and/or decompressed by decompression logic 353 after being retrieved from graphics memory 355. Whether or not one or the other of compression logic 352 or decompression logic 353 is used may depend upon characteristics of a specific piece of graphics data being stored within or retrieved from graphics memory 355, as well as depending upon the specific compression and decompression algorithms used.

Frame buffer image 369 is a bitmap of the main portion of the image to be shown by display 359. Most pieces of graphics data that are to be shown on display 359 are written by graphics controller 350 into a portion of graphics memory 355 that stores frame buffer image 369, and frame buffer image 369 is retrieved from graphics memory 355 and transmitted to display 359. As will be familiar to those skilled in the art, many commonly used forms of display 359 require frame buffer image 369 to be repeatedly retransmitted to display 359 at regular intervals to display 359 at a rate chosen to be faster than can be perceived by the human eye in a process commonly referred to as “refreshing” display 359 at a “refresh rate” that is faster than can be perceived by the human eye. Depending on the nature of the interface between graphics controller 350 and display 359, as well as characteristics of frame buffer image 369, graphics controller 350 may be further made up of display encoder 358 to aid in transmitting frame buffer image 369. For example, display encoder 358 may provide color depth conversion where frame buffer image 369 is represented with a number of bits per pixel that is different than a number of bits per pixel used in transmitting frame buffer image 369 to display 359. Also by way of example, display encoder 358 may provide color space conversion in cases where, for instance, frame buffer image 369 is stored in RGB format while display 359 requires the transmitting of frame buffer image 369 in YUV format. Gamma correction, alpha blending and still other functions may also be carried out by display encoder 358.

Overlay bitmap 361 is a two-dimensional pixel representation of an image that is typically combined with frame buffer image 369 such that the image provided by overlay bitmap 361 is seen on display 359 as overlying frame buffer image 369, often with some portion of the image of overlay bitmap 361 being transparent such that the underlying image of frame buffer image 369 is allowed to show through that portion. A common example of such an overlying image is a “pointer” or “mouse cursor.” However, although some embodiments may store overlay bitmap 361 within graphics memory 355, as depicted in FIG. 3, other embodiments may store overlay bitmap 361 within display encoder 358, especially if the overlying image is as small as a typical pointer or mouse cursor. Font bitmaps 362 is a set of two-dimensional pixel representations of images of textual and/or numerical characters that are selected and copied to create larger images of words, equations, etc., often by copying the selected characters into portions of frame buffer image 369.

In various possible embodiments, graphics system 300 may allocate a portion of graphics memory 355 to provide blitter scratchpad 363 for use by logic within graphics controller 350 dedicated to carrying out the copying and/or moving of bitmaps or portions of bitmaps from one portion of graphics memory 355 to another, a graphics operation commonly referred to as “bit blitting.” In such operations, blitter scratchpad 363 may be used to temporarily store at least a portion of a bitmaps being copied and/or moved.

Still image 364 may be a two-dimensional pixel representation of a photograph, a computer-generated image (such as a cartoon character, view of a three-dimensional model of an object, etc.), or other two-dimensional image. Motion video frames 365 is a set of two-dimensional pixel representations of live action, computer generated or other forms of motion video imagery. Graphics system 300 receives still image 364 from an outside source, such as graphics source 330, from across a bus linking graphics system 300 to a portion of a computer system or other electronic device, etc. In various embodiments, graphics system 300 may receive at least a portion of either still image 364 or motion video frames 365 from an outside source, such as graphics source 330.

Polygon data 366 is a set of coordinates and/or other numerical data describing the shape, size, position and/or orientation of one or more polygons or other elements (e.g., nurbs, fractals, wavelets, etc.) making up a three-dimensional model of an object. Texture map 367 is a two-dimensional pixel representation of a texture and/or color pattern that may be painted onto a surface of a polygon or other element as part of creating a view of a three-dimensional object. Z-buffer data 368 is a set of indices and/or other form of numerical data indicating the depth of a pixel, polygon and/or other element of an image relative to other elements of the same image, i.e., the relative depth positions of elements within an image from a given perspective to aid in determining which elements overlap which other elements from that perspective.

Pieces of graphics data that are two-dimensional pixel representations of images, such as overlay bitmap 361, font bitmaps 362, blitter scratchpad 363, still image 364, motion video frames 365, texture map 367, and frame buffer image 369, may be amenable to being compressed by compression logic 352 employing a lossy compression algorithm chosen to take advantage of limitations in what forms of loss of visual data are less likely to be perceived by the human eye. However, some of these pieces of graphics data may be more amenable to some lossy compression techniques than others, and as those skilled in the art will recognize, it is sometimes preferable to choose one lossy compression technique over another depending on the specific characteristics of the type of graphics data to be compressed. For example, some lossy compression techniques may be more optimal for compressing natural images in which variations in colors between adjacent pixels tend to be less extreme than is often encountered in artificially generated images (such as cartoons, pie charts, images of three-dimensional models, etc.), or some lossy compression techniques may provide less favorable results for images having a plethora of orthogonal lines (such as images of text characters). As a result, particularly where cost or other considerations may result in compression logic 352 employing a limited number of possible compression techniques, it may be the case that compression logic 352 is employed to compress a subset of these pieces of graphics that are two-dimensional pixel representations of images. For example, in some embodiments, compression logic 352 may be employed to compress still image 364, motion video frames 365, texture map 367 and frame buffer image 369, while not being employed to compress overlay bitmap 361, font bitmaps 362 and blitter scratchpad 363, despite these latter pieces of graphics data being representations of two-dimensional arrays of pixels, because the lossy compression techniques employed by compression logic 352 may introduce undesirable artifacts in images having numerous orthogonal lines, such as text characters or certain images of mouse cursor. Alternatively, compression logic 352 may selectively employ one of multiple lossy compression techniques from which a selection is made based on the type of graphics data to be compressed (and with decompression logic 353 employing a corresponding selection of lossy decompression techniques).

In contrast to pieces of graphics data that are two-dimensional pixel array image data for which lossy compression may be considered, pieces of graphics data that represent coordinates, orientation, relative depth, and/or other numerical information, such as polygon data 366 and z-buffer data 368, may not be so amenable to being compressed by any form of lossy technique, since incurring the losses would necessarily result in the introduction of unacceptable errors into such mathematical information. In short, it may be that graphics data made up of numerical values specifying the position, orientation, etc., of elements depicted within an image may not be able to tolerate alterations to even relatively small proportions of bits in those numerical values that would be expected to be introduced by lossy compression techniques. As a result, some embodiments may avoid the use of any compression techniques with graphics data made up of numerical information. Alternatively, other embodiments may entail the use of lossless compression techniques with graphics data made up of such numerical data, possibly with compression logic 352 being capable of employing both lossy and lossless compression techniques depending on the type of graphics data (and with decompression logic 353 employing corresponding lossy and lossless decompression techniques).

Furthermore, whether or not a piece of graphics data is received by graphics controller 350 in compressed form, and the choice of compression techniques that were used to compress that piece of graphics data may, in some embodiments, both be factors in determining whether or not that piece of data is subsequently compressed or decompressed by compression logic 352 or decompression logic 353. For example, if a piece of graphics data is received from graphics data source 330 in an uncompressed form, then in some embodiments, that piece of graphics data may be compressed by compression logic 352 before being stored in graphics memory 355, if the piece of graphics data is of a type on which compression by compression logic 352 would be carried out. Alternatively, if a piece of graphics data is received from graphics data source 330 in a compressed form using a compression technique not employed by compression logic 352, then in some embodiments, data decoder 332 may be provided to decompress that piece of graphics data using a technique corresponding to the technique by which it was compressed, and then compression logic 352 may subsequently compress the now decompressed piece of graphics data, if that piece of graphics data is of a type on which compression by compression logic 352 would be carried out. However, if a piece of graphics data is received from graphics data source 330 in a compressed form using a compression technique similar to a compression technique employed by compression logic 352, then that piece of graphics data may be stored into graphics memory 355 without either decompression or compression being carried out on that piece of graphics data, if that piece of graphics data is of a type on which compression by compression logic 352 would not be carried out.

Similarly, if a piece of graphics data is retrieved from graphics memory 355 in a compressed form, then that piece of graphics data may be transmitted to graphics data recipient 340 without decompression by decompression logic 353, if graphics data recipient 340 is configured to receive that graphics data in a compressed form using a compression technique employed by compression logic 352. Alternatively, if a piece of graphics data is retrieved from graphics memory 355 in a compressed form that graphics data recipient is not configured to receive, then that piece of graphics data may be decompressed by decompression logic 353. If graphics data recipient 340 is configured to receive graphics data compressed via a technique not employed by compression logic 352, then data encoder 342 may be provided to compress that graphics data using a compression technique for which graphics data recipient 340 is configured before that graphics data is transmitted to data recipient 340.

FIG. 4 is a flowchart of an embodiment of graphics data compression carried out by compression logic, such as compression logic 152, 252 or 352 of FIG. 1, 2 or 3. In some embodiments, a variation of compression conforming to at least some of the requirements of the well-known and widely used Joint Photographic Experts Group (JPEG) standard (ISO 10918-1) is employed to compress graphics data, and in other embodiments, other forms of compression techniques may be used.

In some embodiments, graphics data that is in RGB colorspace is converted to one of multiple possible forms of YUV colorspace at 410. Alternatively, in other embodiments, conversion to a YUV colorspace may not take place, especially where graphics data is received in a form that is already in a YUV colorspace. To aid in achieving a high compression ratio in some variations, a form of YUV colorspace may be used in which the chroma components (i.e., the U and V components) of the graphics data are subsampled in comparison to the sampling of the luminance component (i.e., the Y component) in recognition of the human eye perceiving luminance at a higher definition than chrominance. In other variations, a form of YUV colorspace may be used in which neither the luminance nor chrominance components are subsampled relative to each other in order to avoid the creation of undesirable visual artifacts such as the blurring of lines of only a single pixel in width when chrominance subsampling is employed. Such undesirable visual artifacts could make the compression of graphics data that includes textual characters undesirable as the relatively thin orthogonal lines making up text characters may be made unacceptably blurry.

In still other embodiments, at 410, graphics data in RGBA colorspace, i.e., RGB colorspace with the addition of an alpha data (an “A” component) for such data as alpha blending, etc., may be converted to YUVA colorspace. Again, as with YUV colorspace graphics data discussed above, subsampling may or may not be used depending on the degree to which various possible visual artifacts are able to be tolerated.

At 420, graphics data is divided into blocks of pixels, and a forward discrete cosine transform (FDCT, or simply “DCT”) is carried out that separately transforms the luminance and chrominance values (and perhaps the alpha values) of the pixels in each of the blocks into DCT coefficients. For example and additionally referring to FIGS. 5a and 5b, pixels 510 of graphics data 500 are divided up into blocks 520 that are made up of 8×8 square arrays of pixels in some embodiments, as depicted in FIG. 5a. Alternatively and also by way of example, pixels 510 of graphics data 500 are divided up into blocks 520 that are each made up of 4×4 square arrays of pixels, as depicted in FIG. 5b in some embodiments. Still other embodiments may divide the pixels of graphics data into blocks of having other quantities and/or configurations of pixels. Through the forward DCT transform, the luminance, chrominance, and perhaps alpha, values for each one of the two-dimensional blocks 520 of pixels making up the graphics data is separately transformed into a corresponding two-dimensional block of DCT coefficients, such that separate two-dimensional blocks of DCT coefficients for each of the luminance, chrominance, and perhaps alpha, values are generated. Some embodiments may employ a form of forward DCT that is compliant with JPEG. Alternate embodiments may employ other transforms that are not compliant with JPEG, but which have the advantage of being simpler to implement, including the well known 4×4 GBT commonly employed for H.26L in MPEG-4 (Motion Picture Expert Group 4—one of a widely known and used series of motion image compression techniques), or the also well known Hadamard transform often used in experimental forms of video encoding.

At 430, each of the blocks of DCT coefficients (i.e., the luminance, chrominance, and perhaps alpha blocks of DCT coefficients) corresponding to one of blocks 520 of graphics data 500 is quantized to remove DCT coefficient values (i.e., replace those values with the value of zero) deemed amenable to being deleted without causing the resulting image to become perceptibly degraded to an undesirable degree. In some embodiments, this quantization is carried out by quantization logic within a compression logic that uses one or more (perhaps, up to four) quantization tables modified with a scaling value received by the quantization logic as feedback from the monitoring the rate and/or results of the forward DCT and quantization on a previous one of blocks 520. In some embodiments, a standard JPEG quantization table may be used, and in alternate embodiments, one or more quantization tables customized to avoid introducing blurring of orthogonal lines in textual characters, for example, or customized to achieve other specific results (possibly derived through experimentation) may be used.

At 440, in some embodiments, the results of the forward DCT and/or quantization of one of blocks 520 is monitored to determine if a desired compression ratio (e.g., 4:1) has been reached. In some embodiments, the rate of DCT and/or quantization of blocks 520 is monitored to determine if a desired rate of compression of blocks 520 is being met. Regardless of the criterion for which the forward DCT and/or quantization of one or more of blocks 520 is being monitored to meet, logic used to carry out this monitoring may provide feedback for at least the quantization of subsequent ones of blocks 520. This feedback may be in the form of a scaling value to modify one or more quantization tables for use in the quantization of a subsequent ones of blocks 520.

At 450, in some embodiments, the blocks of now quantized DCT coefficients for luminance, chrominance, and perhaps alpha, for each one of blocks 520 may be reorganized starting with a coefficient in one corner of each two-dimensional block of DCT coefficients and proceeding through the coefficients within that block to the coefficient in the diagonally opposite corner in a diagonally oriented “zigzag” pattern widely known and used by those skilled in the art and familiar with JPEG compression techniques (commonly referred to as “zigzag ordering”) to create separate sequences of quantized DCT coefficients for luminance, chrominance, and perhaps alpha, for each one of blocks 520. Such zigzag ordering may be used in recognition of the conversion of graphics data from a spatial domain to a frequency domain that at least some implementations of forward DCT brings about, and in recognition of the possible opportunity to remove components of frequencies less likely to be perceived by the human eye that at least some implementations of quantization take advantage of.

Making use of this possible combination of conversion to frequency domain and removal of less important frequency components may result in an ordering of the quantized DCT coefficients into a sequence of quantized DCT coefficients that attempts to group together many of the zero values at one end of the sequence. Such a grouping of zero values towards one end of the sequence (if accomplished) may provide a further opportunity for compression through encoding the coefficients within each of the sequences of coefficients for each of the luminance, chrominance, and perhaps alpha, components of the pixels of one of blocks 520 into a concatenated sequence of bits or “symbol” representing coefficients being encoded together with at least groups of adjacent zero values being more compactly described so that valuable space is not taken up to store a run of zero values. The resulting separate symbols for luminance, chrominance, and perhaps alpha, that correspond to each one of blocks 520 are of variable length, i.e., it is likely that a symbol for the luminance component for one of blocks 520 will be of a different length than either of the two symbols for the two chrominance components (or for the alpha component, if there is one) for the same one of blocks 520, and it is also likely that any symbol for one of blocks 520 to be of a different length than any of the symbols for any of the components of another one of blocks 520. Various possible embodiments may use Huffman coding, various forms of arithmetic coding and/or other forms of run length limited (RLL) coding, etc. to effect this compression of zero values. Putting together the luminance symbol, the two chrominance symbols, and if present, the alpha symbol, for one of blocks 520 creates a bitstream that corresponds to that one of blocks 520.

At 460 and additionally referring to FIGS. 6a and 6b, bitstreams corresponding to each of blocks 520 of graphics data 500 (such as bitstreams 691-694, provided as examples for sake of discussion, only) are stored at a byte-aligned address locations within a memory system (e.g., system memory 125; graphics memory 155 or 355; or memory system 255 or 655 depicted variously in FIGS. 1, 2, 3, 6a and 6b). In some embodiments, zero-filling may be employed to fill in the unoccupied bits of the last byte, word, dword, etc., occupied by only a portion of each of bitstreams 691-694. Furthermore, it may be that each symbol within each of bitstreams 691-694 are also byte-aligned and bits unoccupied by one or more of those symbols may also be similarly zero-filled within bitstreams 691-694. At 470, a memory controller (such as memory controller 354 of FIG. 3) operating memory system 655 assigns an index value to each of bitstreams 691-694 and creates corresponding entries 661-664 in index table 654 that each individually store the starting address within memory system 655 for each of bitstreams 691-694, as depicted in FIG. 6a. Maintaining index table 654 enables speedier access to the data for a given pixel by retrieving only the one of bitstreams 691-694 corresponding to the one of blocks 520 in which the given pixel resides and decompressing only that bitstream to obtain the data for that block. Without such indexing, it may be necessary to retrieve all the bitstreams (including bitstreams 691-694) for all of the blocks 520 making up graphics data 500, and searching through each of the bitstreams making up graphics data 500 to find the bitstream corresponding to the correct one of blocks 520.

Alternatively and referring again to FIGS. 5a and 5b, blocks 520 may be divided among clusters 530 of blocks of pixels (with four blocks of pixels 520 being depicted as belonging to each cluster 530, as an example, though other quantities of blocks could make up a cluster in other embodiments), and it may be that all of bitstreams corresponding to blocks 520 making up one of clusters 530 are assembled together so that a whole one of clusters 530 may be stored as a cluster 681 of bitstreams 691-694 at a byte-aligned address location within memory system 655, as depicted in FIG. 6b. In such embodiments, a single entry 661 may be created in index table 654, at 470, for only the starting address for cluster 681 corresponding to the given one of clusters 530, and not for individual bitstreams 691-694 corresponding to given ones of blocks 520 within the given one of clusters 530. In such embodiments, entry 661 for cluster 681 corresponding to a given one of clusters 530 may additionally store offsets 671-674 from the starting address for group 681 to the starting addresses of each of bitstreams 691-694 corresponding to each of the given blocks 520 within the given one of clusters 530.

FIG. 7 is a flowchart of an embodiment of graphics data decompression carried out by decompression logic, such as compression logic 153, 253 or 353 of FIG. 1, 2 or 3. In some embodiments, a variation of decompression conforming to at least some of the requirements of the well-known and widely used Joint Photographic Experts Group (JPEG) standard (ISO 10918-1) is employed to compress graphics data, and in other embodiments, other forms of decompression techniques may be used.

At 710 and additionally referring variously to FIGS. 5a, 5b, 6a and 6b, index table 654 is accessed to retrieve each bitstream corresponding to each one of blocks 520 making up graphics data 500 from memory system 655. At 720, each bitstream is decoded to retrieve the sequence of quantized DCT coefficients encoded into each bitstream that correspond to each one of blocks 520.

At 730, the retrieved quantized DCT coefficients are reordered from a sequence that may have been created through zigzag ordering into a two-dimensional block of quantized DCT coefficients. At 740, an inverse discrete cosine transform (IDCT) is carried out that transforms the quantized DCT coefficients into the luminance and chrominance components for each pixel of each one of blocks 520. Blocks 520 are then reassembled to bring together the pixels that make up graphics data 500.

In some embodiments, the now decompressed graphics data that is in a form of YUV colorspace is converted to one of multiple possible forms of RGB colorspace at 750. Alternatively, in other embodiments, conversion to a RGB colorspace may not take place, especially where the now decompressed graphics data is to be transmitted to a recipient of graphics data that is compatible with graphics data in a YUV colorspace (e.g., a television) or where the graphics data is otherwise used in a YUV colorspace.

FIG. 8 is a block diagram of embodiments employing decompression logic not dissimilar to decompression logics 153, 253 and 353 of FIGS. 1, 2 and 3, respectively, employed in an example decompression of at least a portion of graphics data in the form of texture maps 867. Texture maps 867, not unlike earlier described texture maps 367, is a is a two-dimensional pixel representation of a texture and/or color pattern that may be painted onto a surface of a polygon or other element as part of creating a view of a three-dimensional object, and is stored within memory system 855.

To be decompressed, at least a bitstream made up of symbols for a two-dimensional block of pixels from within texture maps 867 is retrieved from memory system 855 and provided as an input to luminance symbol decoder 871a, chrominance symbol decoders 871b and 871c, and perhaps alpha symbol decoder 871d, if a symbol for an alpha component is provided within the bitstream. Luminance symbol decoder 871a decodes the symbol into which quantized DCT coefficients for luminance were encoded to retrieve those coefficients. Likewise, chrominance symbol decoders 871b and 871c, along with alpha symbol decoder 871d, each decode their respective symbols to retrieve the corresponding coefficients. The now retrieved quantized DCT coefficients for luminance (i.e., “Y”), both forms of chrominance (i.e., “U” and “V”), and alpha (i.e., “A”) are provided to luminance IDCT 872a, chrominance IDCT 872b and 872c, and alpha IDCT 872d, respectively, where these DCT coefficients are transformed to retrieve luminance, chrominance, and perhaps alpha, components for a two-dimensional block of pixels of texture maps 867. The components for luminance and chrominance are, in turn, provided to YUV-to-RGB colorspace converter 873, to retrieve RGB components for each of these pixels. The RGB components, along with the alpha component (again, if there is an alpha component), are provided to texture cache 876 of texture processing logic 875. Pixel shader 877 and tesslator 878 of texture processing logic 875 make use of the component data for these pixels, now stored in texture cache 876, to paint at least a portion of a surface of a three-dimensional object being rendered.

Although the discussion of this example of decompression focused on the use of just one decompression logic, namely decompression logic 853a, other example embodiments may employ more than one decompression logic in parallel, such as decompression logics 853b through 853d in addition to 853a. The number of parallel decompression logics may be chosen to correspond with the number of blocks of graphics data making up a cluster of blocks, such as having a set of four parallel decompression logics to decompress all four blocks 520 making up cluster 530 in FIGS. 5a and 5b.

In some embodiments, luminance IDCT 872a, chrominance IDCT 872b and 872c, and alpha IDCT 872d all employ similar implementations of IDCT algorithm which may afford the advantages of simplifying the design of decompression logics 853a-d through such reuse of logic. Alternatively, one or more luminance IDCT 872a, chrominance IDCT 872b and 872c, and alpha IDCT 872d may implement differing algorithms, perhaps with one or more of the selected algorithms being specialized for the Y, U, V and/or A component for which it is employed. A possible algorithm is combined a fast integer two-dimensional IDCT and dequantization.

In some embodiments, decompression logics 853a, 853b, 853c and/or 853d may be employed to decode a portion of texture maps 867 with just one pass through all the blocks making up that portion of texture maps 867. Alternatively, especially where the volume and/or a characteristic of a portion of texture maps 867 is such that attempting to carry out a complete decompression of that portion is not possible or not desirable due to time or performance constraints, a form of multi-resolution decompression such that the portion is decompressed in successive passes to provide a “progressive refinement” of the output of decompression logics 853a, 853b, 853c and/or 853d may be employed. In other words, a less time-consuming or otherwise less demanding form of decompression may be carried out where in less than all of the blocks and/or less than all of the symbols (e.g., 1 out of every 2, or 4, or 8) in each block is decompressed in a first pass to provide a “rough” form of decompressed graphics data, followed by one or more successive passes of decompression in which more of the blocks and/or more of the symbols would be decompressed to progressively refine the resulting decompressed graphics data over time. Such a progressive refinement approach may be employed to enable the implementation of decompression logics 853a, 853b, 853c and/or 853d with simplified designs.

The invention has been described in some detail with regard to various possible embodiments. It is evident that numerous alternatives, modifications, variations and uses will be apparent to those skilled in the art in light of the foregoing description. It will be understood by those skilled in the art that the present invention may be practiced in support of many possible types of graphics hardware memory devices employing any of a number of possible types of graphics data. It will also be understood by those skilled in the art that the present invention may be practiced in support of electronic devices other than computer systems such as audio/video entertainment devices, controller devices in vehicles, appliances controlled by electronic circuitry, etc.

1. An electronic system comprising:
a memory system of which at least a portion is allocated as a frame buffer to store frame buffer graphics data to be repeatedly retransmitted to a display device wherein the image incorporates at least one text character; and
a graphics controller coupled to the memory system, the graphics controller having compression logic employing a lossy compression algorithm to compress the frame buffer graphics data to be stored in the frame buffer, and having decompression logic to repeatedly decompress the frame buffer graphics data as the frame buffer graphics data is repeatedly retrieved from the frame buffer to be repeatedly retransmitted to the display device.

2. The electronic system of claim 1, further comprising a processor coupled to the memory system and sharing the memory system with the graphics controller such that the processor executes instructions stored in the memory system.

3. The electronic system of claim 2, further comprising a graphics data source accessible to the processor such that the processor controls the provision of input graphics data by the graphics data source to the graphics controller.

4. The electronic system of claim 1, wherein the compression logic utilizes a discrete cosine transform and quantization of DCT coefficients generated by the discrete cosine transform.

5. The electronic system of claim 1, wherein the compression logic converts the frame buffer graphics data to YUV colorspace.

6. The electronic system of claim 5, wherein the compression logic samples chrominance values in a 1:1 ratio with luminance values to limit blurring an orthogonal line of the at least one text character.

7. The electronic system of claim 1, further comprising a graphics data source coupled to the graphics controller such that the graphics controller receives input graphics data from the graphics data source, wherein the input graphics data is received in a compressed form, is stored by the graphics controller into the memory system while bypassing the compression logic, and is retrieved by the graphics controller from the memory system to be decompressed by the decompression logic.

8. The electronic system of claim 1, further comprising a font bitmap of an image of the at least one text character that is compressed by the compression logic, stored in the memory system, and is retrieved by the graphics controller from the memory system to be decompressed by the decompression logic.

9. An electronic system comprising:
a memory system of which at least a portion is allocated to store a font bitmap providing an image of at least one text character; and
a graphics controller coupled to the memory system, the graphics controller having compression logic employing a lossy compression algorithm to compress the font bitmap data in preparation for storage in the memory system, and having decompression logic to decompress the font bitmap data.

10. The electronic system of claim 9, further comprising a processor coupled to the memory system and sharing the memory system with the graphics controller such that the processor executes instructions stored in the memory system.

11. The electronic system of claim 10, further comprising a graphics data source accessible to the processor such that the processor controls the provision of input graphics data by the graphics data source to the graphics controller.

12. The electronic system of claim 11, wherein the compression logic utilizes a discrete cosine transform and quantization of DCT coefficients generated by the discrete cosine transform.

13. The electronic system of claim 9, further comprising frame buffer data incorporating font bitmap data that is decompressed by the decompression logic, wherein the frame buffer data is compressed by the compression logic prior to being stored in the memory system, and wherein the frame buffer data is subsequently decompressed by the decompression logic to be transmitted to a display device coupled to the graphics controller.

14. The electronic system of claim 1, further comprising a graphics data source coupled to the graphics controller such that the graphics controller receives input graphics data from the graphics data source, wherein the input graphics data is received in a compressed form, is stored by the graphics controller into the memory system while bypassing the compression logic, and is retrieved by the graphics controller from the memory system to be decompressed by the decompression logic.

15. A method comprising:
compressing graphics data representing at least a portion of a display image to be transmitted to a display device into compressed graphics data by way of a lossy compression algorithm;
storing the compressed graphics data into a memory system; and
repeatedly retrieving the compressed graphics data from the memory system and decompressing the compressed graphics data to repeatedly transmit the display image to the display device.

16. The method of claim 15, further comprising:
compressing a font bitmap of an image of at least one text character into a compressed font bitmap by way of a lossy compression algorithm;
storing the compressed font bitmap into the memory system;
retrieving the compressed font bitmap from the memory system;
decompressing the compressed font bitmap; and
employing the font bitmap to add an image of the text character to the display image to be transmitted to the display device.

17. The method of claim 16, wherein compressing the font bitmap comprises sampling chroma data in a 1:1 ratio with luminance data to limit blurring of an orthogonal line of the at least one text character.

18. The method of claim 15, further comprising:
receiving input graphics data from a graphics data source;
compressing the input graphics data into compressed input graphics data by way of a lossy compression algorithm;
storing the compressed input graphics data into the memory system;
retrieving at least a portion of the compressed input graphics data from the memory system;
decompressing the portion of the compressed input graphics data into a portion of input graphics data; and
employing the portion of input graphics data to add an image of the portion of input graphics data to the display image to be transmitted to the display device.

19. The method of claim 15, further comprising:
receiving compressed input graphics data that has been compressed by way of a lossy compression algorithm from a graphics data source;
storing the compressed input graphics data into the memory system;
retrieving at least a portion of the compressed input graphics data from the memory system;
decompressing the portion of the compressed input graphics data into a portion of input graphics data; and
employing the portion of input graphics data to add an image of the portion of input graphics data to the display image to be transmitted to the display device.

20. The method of claim 15, wherein compressing the graphics data comprises converting the graphics data into a form of YUV colorspace.

21. The method of claim 20, wherein compressing the graphics data comprises sampling chroma data in a 1:1 ratio with luminance data.
